(19) United States
(12) Patent Application Publication
(10) Pub. No.: US 2025/0363616 A1
(43) Pub. Date: Nov. 27, 2025

(54) MISPICK DETECTION AT A TAPE AND REEL MACHINE SYSTEMS AND METHODS

(71) Applicant: pSemi Corporation, San Diego, CA (US)

(72) Inventors: Shweta Deora, San Diego, CA (US); John Gao, San Diego, CA (US); Doug Hawks, Paulden, AZ (US); Zhaojin Wen, San Diego, CA (US); Tuan Lam, Escondido, CA (US)

(21) Appl. No.: 18/670,655

(22) Filed: May 21, 2024

(51) Int. Cl. G06T 7/00

(52) U.S. Cl. CPC G06T 7/0008; G06T 2207/20081; G06T 2207/20084; G06T 2207/20132; G06T 2207/30148

(57) ABSTRACT

Systems, methods, and computer program products for training and using a machine learning system to identify die mispicks in images of wafers. A machine learning system is trained on a training dataset of historical image data from a tape and reel machine. The historical image data includes images of wafers comprising dies having integrated circuits. The image data is propagated through multiple layers of a neural network in the machine learning system until the neural network is trained to identify die mispicks from the image data. The training dataset also includes synthetic data that is generated from die mispicks in historical image data that are identified using text log files indicating die processing errors. Once trained, the machine learning system is communicatively connected to a tape and reel machine to identify die mispicks in real-time.

### TECHNICAL FIELD

The disclosure generally relates to mispick detection at tape and reel, and more specifically to using machine learning and neural networks for detecting a mispick.

### BACKGROUND

A die is a portion of a wafer that includes an integrated circuit. A wafer may include multiple other dies. The dies are separated from a wafer using a wafer saw. The separated dies (or components) are placed in carrier tape using tape and reel machine. The alignment dies (or reference dies) on the semiconductor wafers are used by the tape and reel machine processing the wafer to properly align the position of the dies on the physical wafer with respect to the wafer map. As the dies are picked by tape and reel machines, some dies could be mispicked due to improper alignment of dies on wafer with respect to the wafer map. This results in bad dies being placed on the carrier tape. The embodiments are directed to identifying mispicked dies at a tape and reel machine, such that the incorrect dies are not packaged and shipped to the customers.

### BRIEF DESCRIPTION OF THE DRAWINGS

FIG. 1A is an exemplary computing environment where embodiments may be implemented.

FIG. 1B is a block diagram illustrating how dies on a wafer are aligned to a wafer map, according to some embodiments.

FIGS. 2A and 2B are images of dies in a wafer, according to some embodiments.

FIG. 3 is a block diagram of a synthetic data generator for generating a synthetic dataset from images of dies from a wafer, according to some embodiments.

FIG. 4 is a block diagram of a machine learning model trained to detect a die mispick, according to some embodiments.

FIG. 5 is a block diagram of an error detection system for detecting a die mispick, according to some embodiments.

FIG. 6 is a diagram of a graph illustrating prediction scores generated by a machine learning system, according to some embodiments.

FIG. 7 is a flowchart of a method for training a machine learning system to detect die mispicks, according to some embodiments.

FIG. 8 is a flowchart of a method for detecting die mispick, according to some embodiments.

FIG. 9 is a flowchart of a method for generating synthetic data for training the machine learning model, according to some embodiments.

FIG. 10 is a block diagram of a computer system suitable for implementing one or more components or operations in FIGS. 1-9 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The embodiments are directed to a multi layered error detection system that detects die mispicks that occur in a die processing service. The error detection system may receive text data and image data. The text data includes log files with alerts that are generated by various components of the die processing service, such as a wafer grinder, a wafer saw, and a tape and reel machine. The image data includes images of wafers that include dies and are generated by various cameras in the die processing service, including cameras at the automated optical inspection machine, the tape and reel machine, or another device in the die processing service.

The text data and image data may be processed and aggregated. For example, incomplete or corrupted text data may be removed, and standardized in a common format. Also, images in the image data may be passed through a filter that lightens or darkens the images. Further text data and image data may be linked using a time stamp.

The error detection system may include a text data error system, an image data error system, and a machine learning system. A text data error system may receive text data and use rules or natural language processing to identify alarms in the data. If alarms are identified, the text data error system may generate an alert. An image data error system may receive image data with images of wafers and determine whether alignment dies images in each of the wafers are missing or shifted. The shift distance may be determined by comparing an alignment die in the images of the wafer to an alignment die for a ground truth image. If a shift distance is more than a predefined shift distance, the image data error system may generate an alert.

The machine learning system may include a neural network, such as a convolutional neural network used to process images. The machine learning system may be trained on historical image data and synthetic image data that includes images of wafers to detect die mispicks in the images. The machine learning system may be trained to generate a prediction which indicates whether an image of the wafer includes or does not include a die mispick. The training may continue until the machine learning system predicts existence of die mispick with an error across historical image data and synthetic image data that minimizes a loss function. Once trained, the machine learning system is incorporated into the error detection system to detect die mispicks in real-time from the image data.

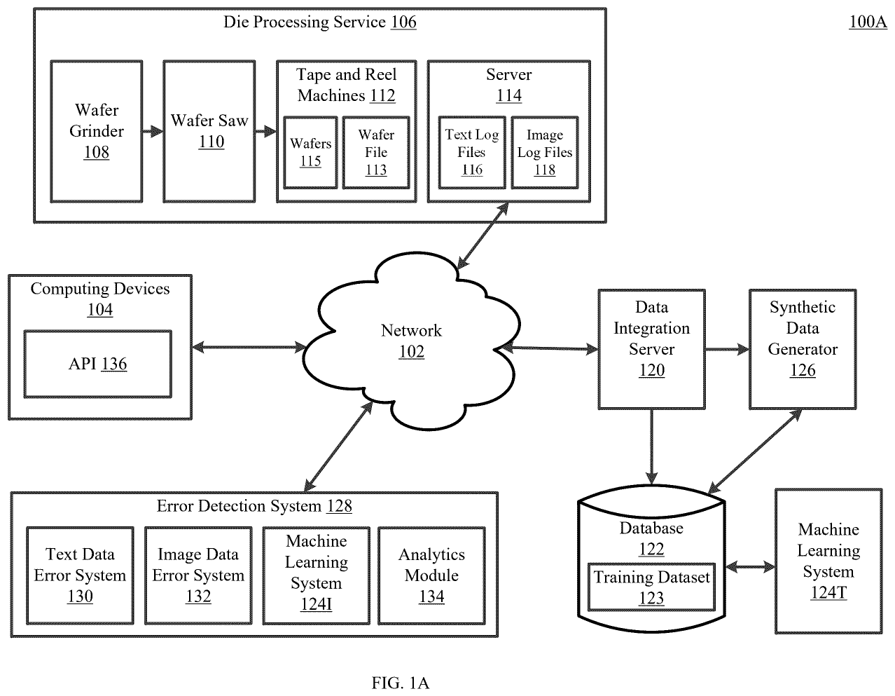

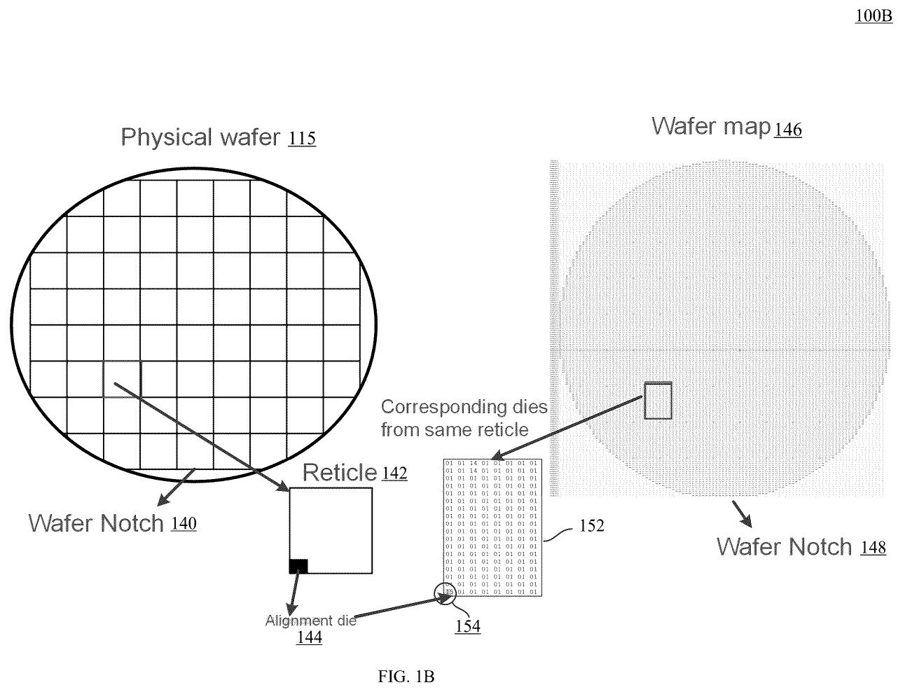

FIG. 1A is an exemplary system 100A where embodiments can be implemented. System 100 may be a computing environment or a computing system. System 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104 and service provider server(s) 106. Computing devices 104 may be portable and non-portable electronic devices under the control of a user and configured to transmit, receive, and manipulate data from over network 102. Example computing devices 104 include desktop computers, laptop computers, tablets, smartphones, wearable computing devices, eyeglasses that incorporate computing devices, implantable computing devices, etc.

Die processing service 106 may be system of hardware machines and servers that are coupled physically or communicatively to generate separated dies (components) from wafers. Die processing service 106 may include one or more wafer grinder(s) 108, wafer saw(s) 110, and tape and reel machine(s) 112. Wafer grinder(s) 108 may reduce a thickness of a wafer 115 in a semiconductor fabrication process before wafer saw. The wafer saw(s) 110 may cut the wafer 115 to separate the dies from the wafer. The tape and reel machine(s) 112 may place the dies on the carrier tape prior to shipping them to various entities.

The tape and reel machine 112 may include a wafer file 113. The wafer file 113 may include a wafer map that may be used to align the dies on wafer 115. The alignment ensures that tape and reel machines 112 selects good dies and places the good dies on the tape. FIG. 1B is a block diagram 100B illustrating how the dies are aligned to a wafer map, according to some embodiments. FIG. 1B illustrates wafer 115 (also shown as physical wafer 115). Wafer 115 includes wafer notches 140 that correspond to edges of wafer 115. Wafer 115 may also include multiple reticles 142. Each reticle 142 may correspond to a pattern that is replicated throughout wafer 115. That pattern may correspond to dies with the integrated circuits. Each reticle 142 also includes an alignment die 144. Alignment die 144 may be in a corner of reticle 142 (as shown in FIG. 1B), in the center of reticle 142, or in another predefined location within reticle 142.

Wafer map 146 may be in an American Standard Code for Information Interchange (ASCII) format that includes text or numbers corresponding to each die in wafer 115. Wafer map 146 may also include wafer notches, such as wafer notch 148 that corresponds to wafer notch 140 of wafer 115. Each reticle 142 in wafer 115 may have a corresponding area, such as area 152 in wafer map 146. Area 152 may indicate, using ASCII text whether the dies in reticle 142 are good dies or bad dies. Good dies are typically placed on the tape for further processing, while bad dies are discarded. For example purposes only, area 152 may indicate good dies using code “01” and bad dies using code “14”. Additionally, area 152 may include an ASCII alignment indication 154 that corresponds to alignment die 144. In area 152, alignment indication 154 may be represented, for example, using code “15”.

Tape and reel machine 112 may align wafer 115 to wafer map 146. For example, tape and reel machine 112 may align alignment die 144 in each reticle 142 to corresponding alignment indication 154. Tape and reel machine 112 may then check alignment between alignment die 144 and corresponding alignment indication 154 for each reticle 142 in wafer 115. Once aligned, tape and reel machine 112 may select good dies (e.g., dies corresponding to code “01”) and place the good dies on the tape. If wafer 115 is not aligned with wafer map 146, tape and reel machine 112 may select bad dies (e.g., dies corresponding to code “14”) and place the bad dies on the tape. The selection of the bad dies is referred to as die mispicks.

In some embodiments, wafer 115 may not include reticles 142. This may happen when wafer 115 is too small (e.g., less than a predetermined wafer size). In this embodiment, alignment dies 144 may be placed on edges of wafer 115, such as at the top, bottom, left, and right sides of wafer 115. The wafer map 146, may then include alignment indications 154 at the top, bottom, left, and right sides of the wafer map 146. Tape and reel machine 112 may then align alignment dies 144 to alignment indications 154 at the top, bottom, and sides of wafer 115.

Die processing service 106 may also include a server 114. Server 114 may be electronic device configured for large scale data processing and service, and may include a physical computer, a server program, or the like, that facilitates data collection and processing. Server 114 may include text log files 116 and image log files 118. As wafer grinder(s) 108, wafer saw(s) 110, and tape and reel machine(s) 112 grind and cut wafers, and/or package dies, wafer grinder(s) 108, wafer saw(s) 110, and tape and reel machine(s) 112 may generate text log files 116 and image log files 118. The text log files 116 and image log files 118 may include information, including wafer and die information, alarms, alerts, time stamps, images, and/or videos related to different steps in the die generation process. The text log files 116 and image log files 118 may be particular to each or a combination of wafer grinder(s) 108, wafer saw(s) 110, and tape and reel machine(s) 112. For example, tape and reel machine(s) 112 may generate text log files 116 that include tape and reel recipes, log files, map data, pocket data, and reel identifiers. Die processing system 106 may include cameras, such as cameras within tape and reel machine(s) 112 that may take images of the dies of a wafer, and store the images in image log files 118. As a result, the image may include images of a wafer that includes dies, images of defective wafers and/or dies, images of misaligned dies, and the like. Text log files 116 and/or image log files 118 may be generated in real-time or at predefined time intervals. In some instances, text log files 116 and image log files 118 may be specific to a machine, such as each tape and reel machine 112, or may be a combination of multiple machines in die processing service 106.

Server 114 may be connected to network 102. Using network 102, server 114 may transmit the data in text log files 116 and/or image log files 118 to data integration server 120. Data integration server 120 may be a computing device or a server program that processes and aggregates data from multiple text log files 116 and image log files 118. For example, data integration server 120 may synchronize data from multiple log files, such as text log files 116 and image log files 118 from each tape and reel machine 112 using time stamps. Data integration server 120 may also remove corrupted or incomplete data from text log files 116 and image log files 118, standardize data in text log files 116 and/or image log files 118 into a common format, and the like. Additionally, data integration server 120 may also run image brightening or darkening algorithms on the images in image log files 118, as needed. Once data integration server 120 processes the data in text log files 116 and image log files 118, data integration server 120 may store data in database 122 or another memory storage conducive for storing and retrieving large amounts of data. Additionally, or alternatively, data integration server 120 may transmit the data to an error detection system 128 that identifies die mispicks as discussed below.

In some instances, database 122 may store data from text log files 116 and image log files 118 over several days, weeks or years. Some or all data stored in database 122 may be included in a training dataset 123 for training machine learning system 124.

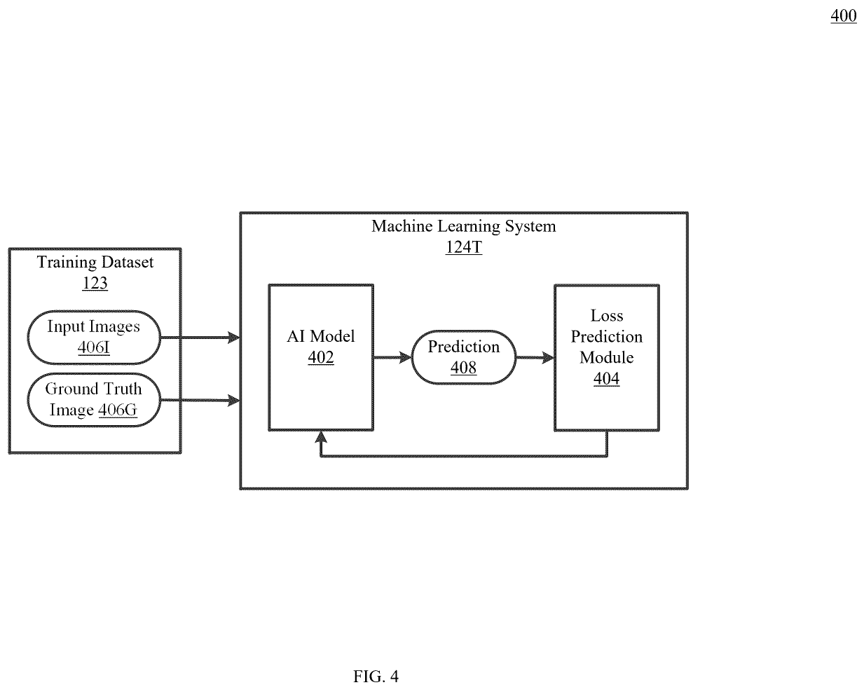

Machine learning system 124 may identify die mispicks in wafers. To identify a die mispick, machine learning system 124 may be trained on training dataset 123. During the training stage, machine learning system 124 may be referred to as machine learning system 124T. The training stage is discussed in further detail in FIG. 4.

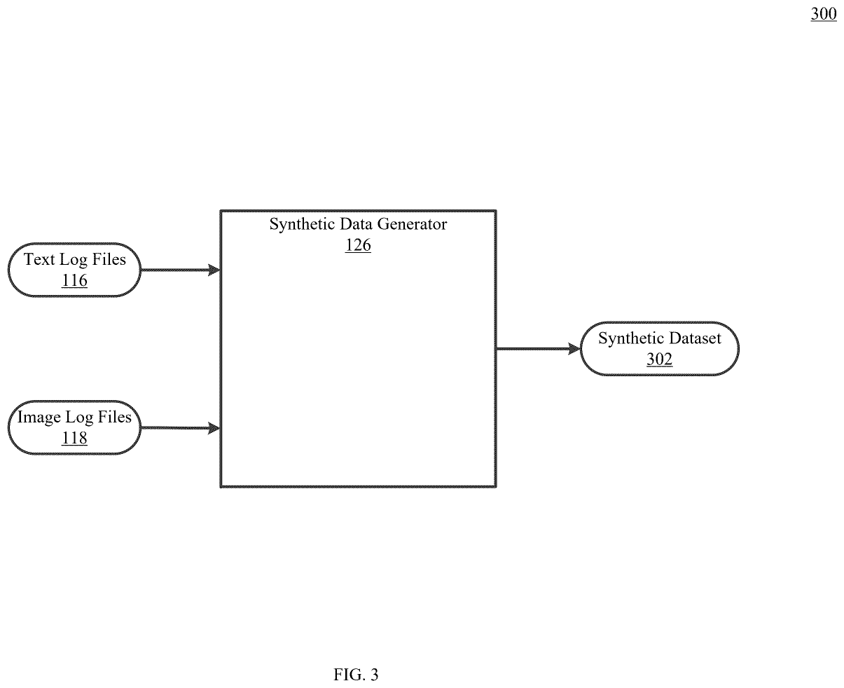

In some embodiments, the training dataset in database 122 may be supplemented with a synthetic dataset. Synthetic dataset may include data that is created synthetically to simulate errors, e.g., die mispicks, but have not been generated by die processing service 106. Synthetic data generator 126 may generate data for the synthetic dataset and store the synthetic data in database 122. Generating a synthetic dataset is discussed in further detail in FIG. 3.

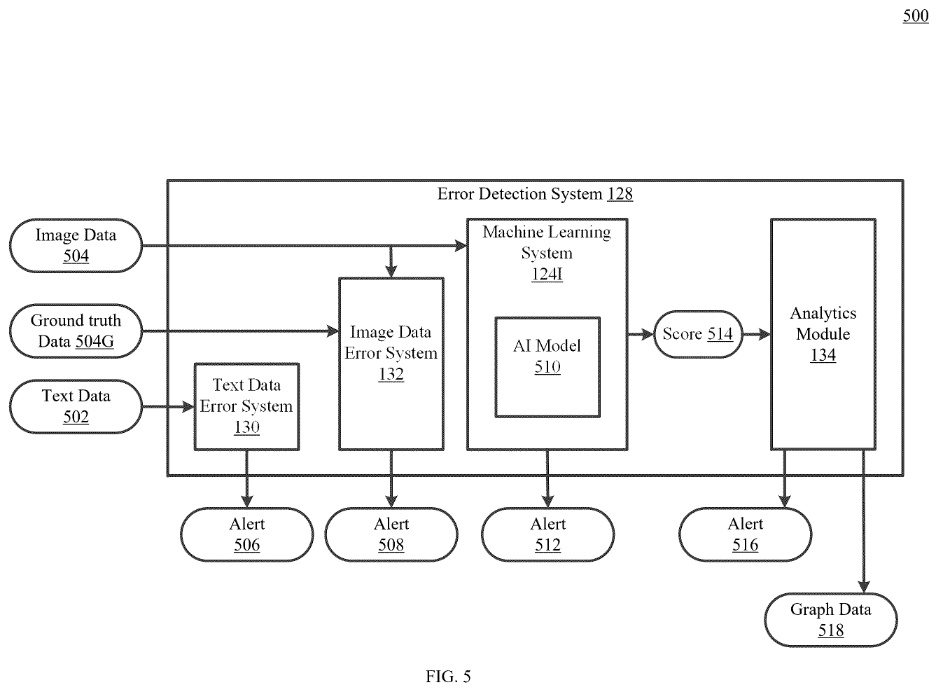

Once machine learning system 124 is trained, machine learning system 124 may enter an inference stage. During the inference stage, machine learning system 124, referred to as machine learning system 124I may be placed in computing environment 100 to identify die mispicks that occur in die processing system 106 in real-time or at predefined time intervals. The inference stage is discussed in further detail in FIG. 5.

Error detection system 128 may be software or a combination of software components that detect errors, such as die mispicks. Error detection system 128 may include a text data error system 130, image data error system 132, machine learning system 124I, and analytics module 134. Text data error system 130, image data error system 132, and machine learning system 124I may operate together or individually to detect die mispicks in die processing service 106. In some instances, error detection system 128 may receive data from text log files 116 and image log files 118 that die processing service 106 generates in real-time or at predefined time intervals. The data may be received over network 102 and extracted from text log files 116 and image log files 118 in real-time or at predefined time intervals. In other instances, error detection system 128 may receive data from data integration server 120 that has processed and synchronized data from text log files 116 and image log files 118.

In some embodiments, text data error system 130 may scan text data in text log files 116 or data received from text log files 116 to identify alarms or alerts raised by the tape and reel machine(s) 112 or other components in die processing service 106. Once error detection system 128 identifies an alarm or alert, error detection system 128 may generate, format and transmit an alert for display on computing device 104. Image data error system 132 may analyze image data of dies in wafers in image log files 118 and detect a shift in an image of a die. The shift may be configured using one or more rules, and may be a shift that is more than one-third or one-half of width or length of a die in a wafer. Once image data error system 132 detects a shift, image data error system 132 may generate an alert for display on computing device 104. Machine learning system 124I may be a trained machine learning system 124 that is in an inference stage. Machine learning system 124I may receive image data from image log files 118 and pass the images through the machine learning system 124I to predict whether dies in the wafer are die mispicks. Die mispicks may be dies that have shifted from dies in a ground truth image. Once image data error system 132 detects die mispicks, image data error system 132 may generate an alert for display on computing device 104.

In some instances, error detection system 128 may include an analytics module 134. Analytics module 134 may track an output of text data error system 130, image data error system 132, and/or machine learning system 124I and generate prediction analytics that indicate a state of die processing service 106. Further description of the error detection system 128 is discussed in FIG. 5.

Computing device 104 may include an application interface (API) 136. Application interface 136 may display alerts and/or data generated using text data error system 130, image data error system 132, machine learning system 124I, and analytics module 134. In some instances, alerts or messages from error detection system 128 may activate API 136, or cause computing device 104 to emit an audible sound indicating an alert from error detection system 128.

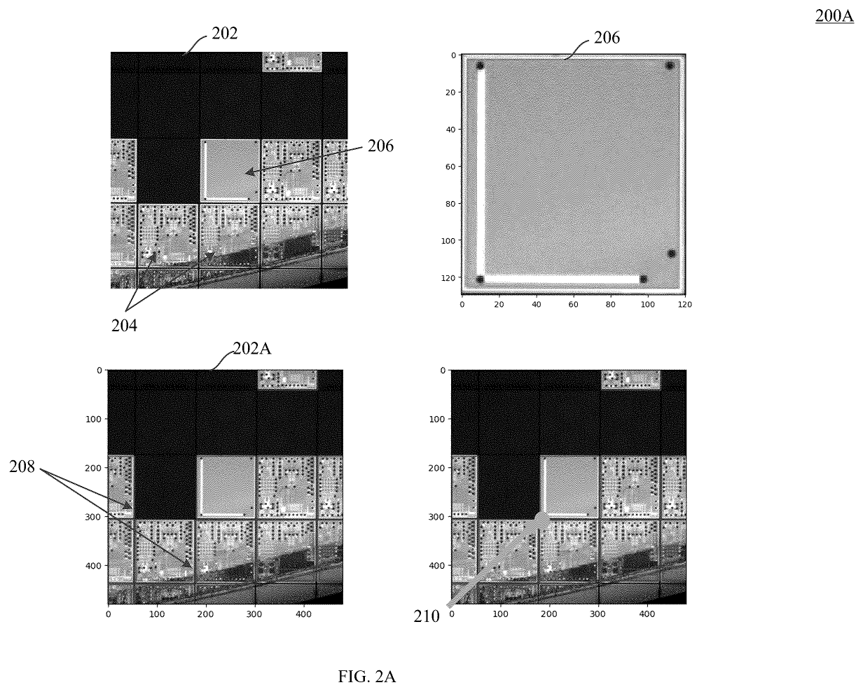

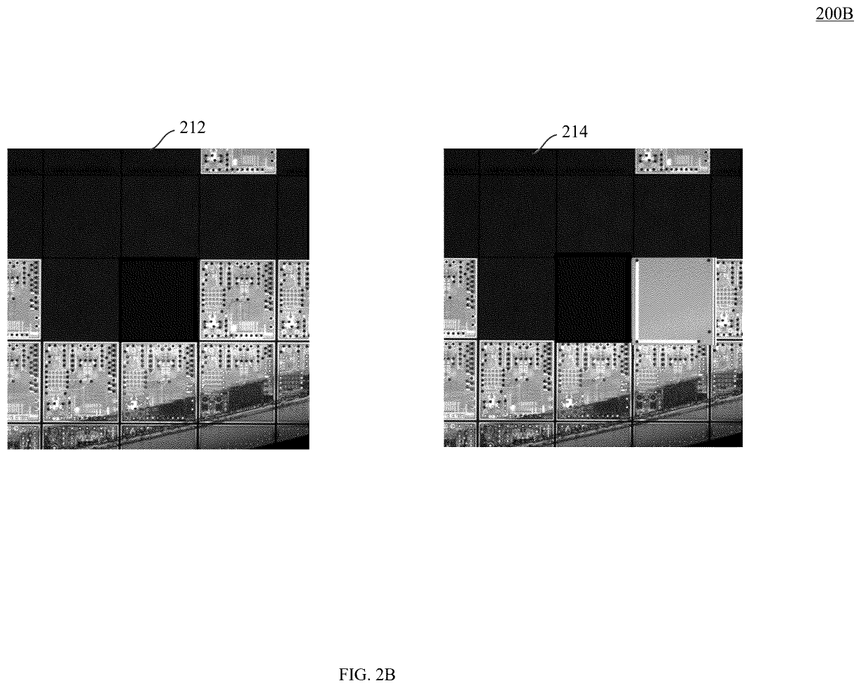

FIGS. 2A and 2B are diagrams 200A-B of dies in a wafer, according to some embodiments. As discussed above, image log files 118 may include images of dies in a wafer. An example image of dies may be image 202. Image 202 may include a portion of a wafer with multiple dies 204 and an alignment die 206. Alignment die 206 (also known as reference die and shown as alignment die 144 in FIG. 1B) may be aligned to the center of the image 204 (or aligned to another known location) collected by camera prior to the alignment die 206 being picked by tape and reel machine 112.

In some instances, image 202 may be fed into an edge detection algorithm to determine edges of the multiple dies 204 and/or alignment die 206 on a wafer. An edge detection algorithm may be a search-based or zero-crossing based algorithm, or the like. The search-based algorithm may determine the edges by first computing a measure of the edge strength (e.g., a first order derivative of the gradient magnitude) and then identifying a local directional maxima of the gradient magnitude, which may be a computing estimate of the local orientation of the edge. The zero-crossing algorithm may search for a zero crossing in a second-order derivative expression computed from the image in order to find edges. The zero crossing may be computed using the Laplacian or non-linear differential expression. In some instances, prior to determining edges, the edge detection algorithm may apply a Gaussian smoothing to reduce noise in image 202. In some embodiments, a Canny edge detection method and/or an Otsu edge detection method may also be used to identify edges of dies 204, 206. FIG. 2A illustrates image 202A that includes edges detected using an edge detection algorithm. Using the detected edges, alignment die 206 and the position 210 of the alignment die 206 in image 202 may be identified and extracted.

Once the alignment dies 206 is identified, machine learning system 124T may be trained to identify images 212 where alignment die 206 is missing and images 214 where alignment die 206 is shifted from the center of images 202 or from a ground truth image (which may be an ideal image 202). FIG. 2B illustrates images 212, 214 that correspond to images with missing and shifted alignment dies 206 respectively. When images 212, 214 include a missing or shifted alignment die 206, the wafer may not be properly aligned with respect to the wafer map, resulting in die mispick.

Machine learning system 124T may be trained on a training dataset 123 that includes ground truth images, such as image 202 where alignment die 206 is centered, images 212 where the alignment die 206 is missing, and images 214 where the alignment die 206 is shifted. Once trained, machine learning system 124T may identify die mispicks in real-time from images 202 generated by die processing system 106. Notably, images 202 may be generated for dies that have different sizes and include different integrated circuits. In this way, machine learning system 124T may be trained to identify die mispicks for different dies and integrated circuit types.

In some embodiments, the training dataset 123 in database 122 may be supplemented with a synthetic dataset. As discussed above, synthetic data generator 126 may generate a synthetic dataset that may be included in training dataset 123. FIG. 3 is a block diagram 300 of a synthetic data generator 126, according to some embodiments. Synthetic data generator 126 may receive historical text data from text log files 116 and historical image data from image log files 118, or processed text and image data that passed through data integration server 120 and stored in database 122. From the data in text log files 116, synthetic data generator 126 may identify alerts or alarms that are associated with images 212 that have a missing alignment die 206 or images 214 that have a shifted alignment die 206. Using the alerts, synthetic data generator 126 may identify corresponding images 212, 214 in and image log files 118. Additionally, synthetic data generator 126 may extract a ground truth image from image log files 118 or database 122.

Using the edge detection algorithm discussed in FIG. 2A, synthetic data generator 126 may determine edges of dies 204, 206 in images 214 and the ground truth image. Using the edges, synthetic data generator 126 may determine the location and center of the alignment die 206 in image 214. A center location of alignment die 206 in image 214 may be referred to as (xₛₐₘₚₗₑ, yₛₐₘₚₗₑ). Similarly, synthetic data generator 126 may determine the location and center of the alignment die 206 in the ground truth image. A center of an alignment die 206 of the ground truth image may be referred to as (x_{ground_truth}) y_{ground_truth}). Using the center of the alignment die 206 in image 214 and the center of the alignment die 206 in the ground truth image, synthetic data generator 126 may determine a shift distance of the alignment die 206 in image 214 with respect to the ground truth image as follows:

$$Shift Distance = ( {d}_{x} , {d}_{y} ) = ( {x}_{sample} , {y}_{sample} ) - ( {x}_{ground \_ truth} , {y}_{ground \_ truth} ) \qquad ( Eq . 1 )$$

Synthetic data generator 126 may repeat the above process for multiple images 214 to identify different shift distances.

Using the shift distances, synthetic data generator 126 may generate a synthetic dataset 302. Synthetic dataset 302 may include shifted images 214 that are generated by cropping images 214 and/or the ground truth image using the various shifted distances and augmenting the cropped images.

In some instances, the synthetic dataset 302 may be specific to a certain die size and wafer size. However, synthetic data generator 126 may generate synthetic dataset from images 214 as discussed above for dies and wafers having various sizes that have various integrated circuits.

Synthetic data generator 126 may store the synthetic dataset 302 as part of the training dataset 123 that trains the machine learning system 124.

FIG. 4 is a block diagram 400 of a machine learning system 124 trained on a training dataset, according to some embodiments. Machine learning system 124T may include an artificial intelligence (AI) model 402 and a loss prediction module 404. AI model 402 may be an artificial neural network (ANN), convolutional neural network (CNN), or another type of neural network conducive to processing and classifying image data. AI model 402 may include multiple layers, including an input layer, hidden layers, and an output layer. Each layer may comprise neurons that are interconnected according to a specific topology. The neurons may be associated with weights and activation functions. The values of the weights may change as the machine learning system 124T is trained. The input layer receives the input data, such as training dataset 123 that includes input images 406I and ground truth image(s) 406G. Hidden layers are intermediate layers between the input and the output layer of the neural network. Hidden layers receive input data processed by the input layer and may extract and transform the input data through a series of weighted computations that correspond to the weights and activation functions at each neuron in the hidden layers. The activation function may be same or different across different layers. Example activation functions may include Sigmoid, hyperbolic tangent, Rectified Linear Unit (ReLU), Leaky ReLU, Softmax, and/or the like.

The output of the hidden layers is passed as input to an output layer. The output layer generates a prediction 408 which is a classification of the input data. The output layer may be a classification layer or a softmax layer. Example prediction 408 may be a binary classification by a classification layer or a probability classification by a softmax layer. In the binary classification, prediction 408 may indicate whether a die in each image in images 406I is the same (not a mispick) or different (is a mispick) from ground truth image 406G. In a probability classification, prediction 408 may indicate a probability that the die in each image in images 406I is the same (not a mispick) or different (is a mispick) from ground truth image 406G.

In the ANN, the input layer, hidden layers, and the output layer may be fully connected layers. In the fully connected layers the neurons of one layer may be fully connected to neurons of the subsequent layers. Each layer may include the same or different number of neurons as the proceeding layer. However, because the neurons are fully connected, when AI model 402 receives images 406I, 406G, images 406I, 406G are converted into image vectors at an input layer and are acted upon and propagated through all neurons of ANN until the output layer generates prediction 408, making ANN computationally expensive.

In some instances, because using ANN may be computationally expensive, AI model 402 may include a CNN. An example CNN may be a ResNet 18 model that may be pre-trained on an image dataset and then finetuned using training dataset 123. A CNN may include one or more convolution layers and pooling layers, followed by fully connected layers, and an output layer. The first convolution layer may be an input layer. The remaining convolution layers, pooling layers, and fully connected layers may be hidden layers. The convolution layers and pooling layers may be interspersed among each other and may be collectively referred to as feature layers. The first convolution layer (e.g., the input layer) may receive input images, e.g., images 406I and ground truth images 406G, whereas other convolutional layers may receive the output of the preceding convolutional layer or the output of a pooling layer.

The convolutional layers perform series of convolution operations on the images. The convolutional operations include applying a number of convolutional filters on the input images at each neuron (e.g., using weights), adding bias, and applying one of non-linear activation functions discussed above. The convolutional layers may extract features from the input images, such as edges, patterns, color, gradient orientation, and the like. Typically, the output of convolutional layers may have a lesser dimension than input images or the output of the preceding layers, but may have more depth.

The pooling layers reduce dimensionality of the input, thus reducing a number of parameters in the input, which in turn reduces a number of computations in the CNN and increases efficiency. Essentially, the pooling layers combine parameters in the received input into a single parameter. A pooling layers may be a maximum pooling layer or an average pooling layer. The maximum pooling layer may identify a maximum value of a portion of an input into the pooling layer, while the average pooling layers may identify an average of a portion of the input. Same or different pooling layers may be interspersed among the convolutional layers in the CNN.

The output of the convolutional layer or pooling layer (whichever is last), may be fed into a first fully connected layer in the fully connected layers. There may be multiple fully connected layers in the CNN. Each neuron in the first fully connected layer receives the output of the convolutional layer or pooling layer as input and processes the input via weights and an activation function as discussed above. The output of the first fully connected layer may be passed to the next fully connected layer, and so on until an output layer is reached. There may be fewer number of neurons in each subsequent fully connected layer than in the preceding layers. Further, each fully connected layer may have the same or different activation function.

The output layer, which may be a classification layer or a softmax layer may receive the output of the last fully connected layer and generate prediction 408, as discussed above.

Loss prediction module 404 may receive prediction 408 and determine whether prediction 408 is correct with respect to images 406I or ground truth image 406G. In particular, images 406I or ground truth image 406G may include labels that identify images 406I, 406G that include and do not include die mispicks. Loss prediction module 404 may compare prediction 408 to the labels of images 406I or ground truth images 406G and identify whether prediction 408 correctly classified images 406I or ground truth image 406G, as well as the cost of error. To determine the cost of error, loss prediction module 404 may use a cost or loss function (e.g., a binary, a categorical, such as ReLU cost function, etc.) associated with a type of classification. As the AI model 402 is trained over multiple iterations of input images 406I and ground truth image 406G, loss prediction module 404 attempts to minimize the cost of error using a back propagation algorithm.

The back propagation algorithm may be a gradient descent algorithm, including a stochastic gradient descent, gradient descent with Adam, gradient descent with momentum, or the like. The back propagation algorithm may receive the cost of error and may determine a change in value that may be applied to the weights of the neurons in the convolutional layers, pooling layers, and fully connected layers, such that the cost of error across training dataset 123 is minimized. The loss prediction module 404 propagates the change in value of the weights in the neurons back into AI model 402.

In some embodiments, machine learning system 124 may receive input images 406I and ground truth images 406G in training dataset 123 over thousands or millions iterations. The training may continue until AI model 402 generates predictions 408 with a cost of error below a cost of error threshold. Once trained, machine learning system 124T may be validated using a validation dataset. The validation dataset may be a portion of training dataset 123, e.g., twenty percent of the training dataset 123 that includes images 406I, 406G that were not included in training machine learning system 124T. Machine learning system 124T may receive the validation dataset and generate predictions 408 for the input images 406I in the validation dataset. The predictions 408 for input images 406I may then be compared against labels of images 406I using loss prediction module 404. Alternatively, predictions 408 may be transmitted for display to API 136 of FIG. 1 (not shown), and validated using API 136. Notably, during the validation stage, the loss prediction module 404 may not propagate changes to the weights to the neurons of AI model 402.

Once machine learning system 124T is trained to determine die mispicks, machine learning system 124 may be included in error detection system 128 of FIG. 1 as machine learning system 124I.

FIG. 5 is a block diagram 500 of an error detection system 128, according to some embodiments. As discussed above, error detection system 128 includes text data error system 130, image data error system 132, and machine learning system 124I. Machine learning system 124I may be machine learning system 124 that was trained using training dataset 123 to identify die mispicks. Machine learning system 124I may receive weights of neurons of AI model 402 from machine learning system 124T. These weights may be set to the corresponding neurons in AI model 510 of machine learning system 124I but otherwise have little to no value for other systems.

Error detection system 128 may receive or request real-time data from die processing service 106 or data processed and synchronized using data integration server 120. The data may be received via network 102 in real-time or at predefined time increments (e.g., every second, every minute, etc.). The data may include text data 502 from text log files 116 and image data 504 from image log files 118. The data may also include the ground truth image.

Text data error system 130 may process text data 502. Text data error system 130 may scan text data 502 and identify alarms or alerts in text data 502. Text data error system 130 may identify alerts or alarms by scanning the text data 502 for predefined alarm/alert words, scanning and processing text data 502 using pre-programmed or configurable rules that may identify alarms/alerts or using natural language processing or large language models to receive text data 502 and identify alarms/alerts. Upon identifying an alarm/alert in text data 502, text data error system 130 may generate alert 506.

Image data error system 132 may receive and processes image data 504. Image data error system 132 may also receive ground truth data 504G that includes a ground truth image or may retrieve the ground truth data 504G from a memory storage (not shown). Image data error system 132 may include preconfigured rule(s) for analyzing image data 504. The rule(s) may include a preconfigured shift of alignment die 206, e.g., shift by more than one third of the die distance from a ground truth position of the die, that may cause image data error system 132 to generate an alert 508. Once image data error system 504 receives image data 504, for each image 202 in image data 504, image data error system 132 may use an edge detection algorithm to determine the center of the alignment die 206 in the ground truth image 504G and the center of the alignment die 206 in image 202 in image data 504. Using the centers, image data error system 132 may determine a shift distance by comparing the two centers as discussed in Eq (1). If the shift distance is more than one third of the width or height of the alignment die 206, image data error system 132 may generate alert 508.

In some instances, the image in image data 504 that caused image data error system 132 to generate alert 508 may be stored in database 122 for inclusion into training dataset 123 (not shown).

Machine learning system 124I may receive image data 504. As discussed above, machine learning system 124 is trained to identify die mispicks from the images 202. Die mispicks may be due to dies 204 being shifted or alignment die 206 being missing from images 202. Machine learning system 124I may retrieve image 202 from image data 504 and pass image 202 through AI model 510 to determine whether image 202 includes die mispicks. AI model 510 may classify images 202 with a true/false classification that indicates whether images 202 include die mispicks. Alternatively, AI model 510 may classify images 202 with a probability classification that indicates a probability that image 202 includes die mispicks. When the classification indicates that image 202 includes die mispicks, machine learning system 124I generates an alert 512.

In some instances, machine learning system 124I may also generate a score 514. Score 514 may correspond to prediction 408 that indicates a probability that image 202 includes die mispicks. Score 514 may be received by analytics module 134. Analytics module 134 may perform predictive analytics on performance of die processing service 106. For example, analytics module 134 may track and analyze scores 514 over a predefined or configurable time period and determine whether the scores 514 indicating that a malfunction or a future malfunction in die processing service 106. An example malfunction may occur when the scores 514 are outside of an average or predefined acceptable score range or are sloping toward the outside of the predefined acceptable score range. When scores 514 are outside of a predefined score range or are sloping toward the out-of-range score, analytics module 134 may generate alert 516. Further, because error detection system 128 may receive image data 504 and text data 502 from different components in die processing system 106, analytics module 134 may link scores 514 to text data 502 and identify a particular machine that may be malfunctioning.

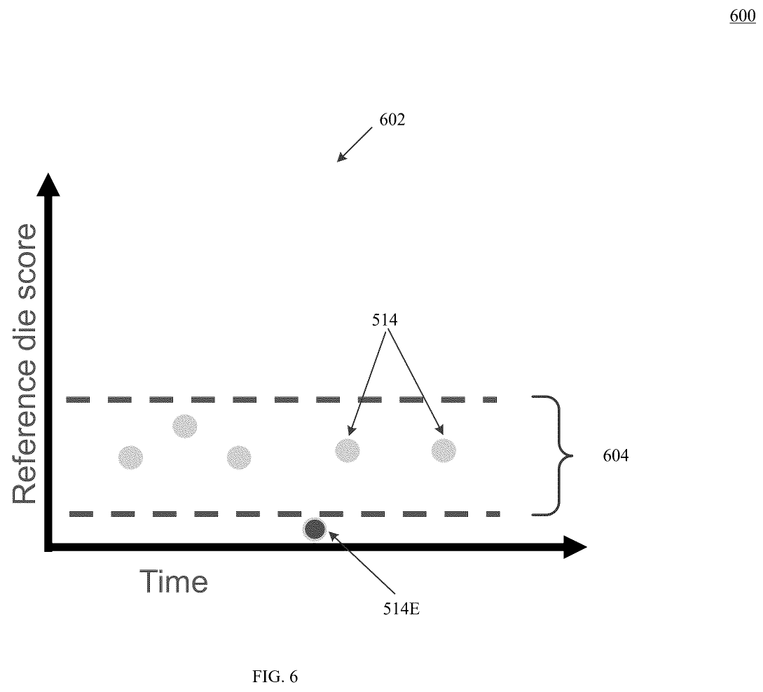

Analytics module 134 may also generate graph data 518 that may include instructions to generate a graph with the scores 514 over a predefined time period. FIG. 6 is a diagram 600 of an example graph 602 illustrating scores 514 over a predefined time period, according to some embodiments. Graph 602 also illustrates an expected range 604 for scores 514 and an out-of-range image score 514E that indicates an error in die processing system 106.

Going back to FIG. 1, API 136 may receive alerts, such as alerts 506, 508, 512, and 516 generated in FIG. 5, and display the alerts on a display screen of computing device 104. Additionally, API 136 may receive data, such as graph data 518 and generate a graph that displays predictions based on scores 514 which are indicative of the state of die processing system 106. In some instances, API 136 may activate once computing device 104 receives alerts 506, 508, 512, and 516. In other embodiments, computing device 104 may issue an audible alert upon receipt of alerts 506, 508, 512, and 516.

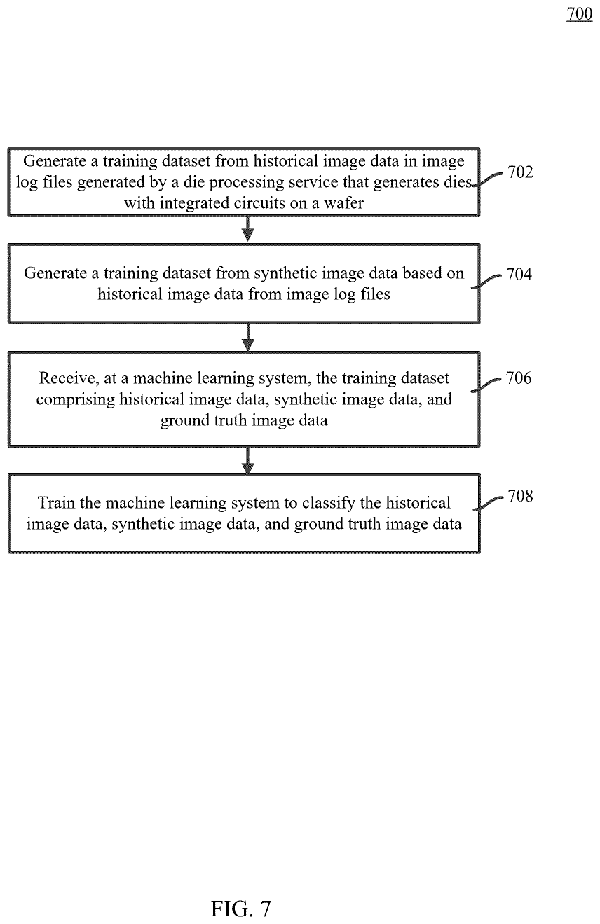

FIG. 7 is a flowchart of a method 700 for training a machine learning system, according to some embodiments. Notably, method 700 is exemplary and other methods may also be used. Method 700 may be performed using hardware and/or software components described in FIGS. 1-5. Note that one or more of the operations may be deleted, combined, or performed in a different order as appropriate.

At operation 702, a training dataset is generated from historical image data. For example, as die processing service 106 may generate dies from wafers using wafer grinder 108, wafer saw 110, and/or tape and reel machine(s) 112, die processing service 106 may generate image log files 118 that includes images 202 of the wafers with dies. Image log files 118 may be transmitted to data integration server 120 that may identify images 202 from image log files 118 and process images 202. Example processing may include cropping images 202, resizing images 202, and rebalancing images 202 by running an image brightening or darkening algorithm on images 202, and the like. Notably, images 202 may be images that include dies for various integrated circuits. Once processed, some or all images 202 may be stored as part of training dataset 123 in database 122. The image 202 in training dataset 123 may further be labelled as images without die mispicks or images with die mispicks (images 212, 214).

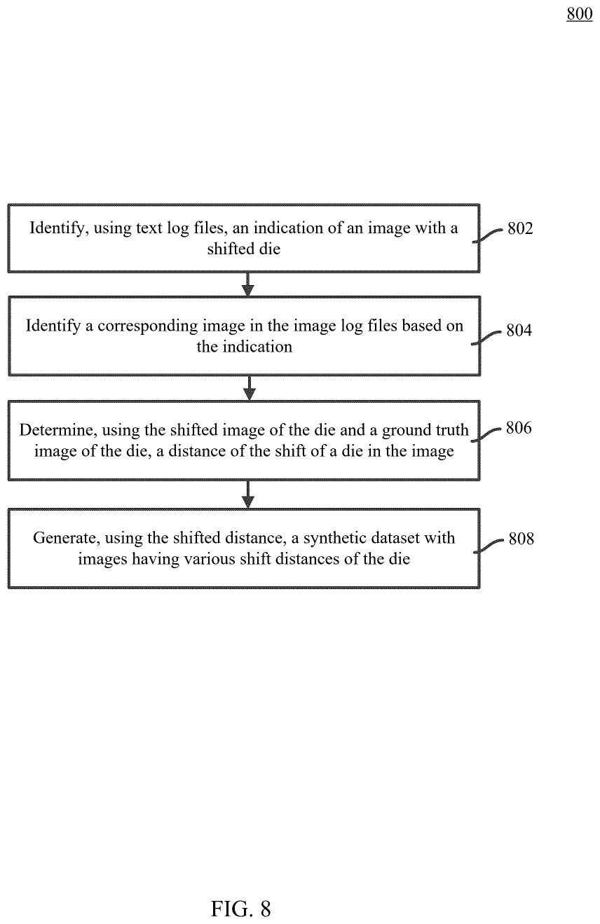

At operation 704, a training dataset is generated from synthetic images. Synthetic dataset 302 may include shifted images 214 that include die mispicks and that are synthetically generated. FIG. 8, discussed below, is a flowchart of a method 800 for generating synthetic dataset 302. Once synthetic dataset 302 is generated, synthetic dataset 302 may be included in training dataset 123. In some instances, operations 702 and 704 may be performed in parallel.

At operation 706, a training dataset that includes historical image data, synthetic image data in synthetic dataset 302 and/or ground truth images is received. For example, machine learning system 124T may receive training dataset 123 that includes images 406I and ground truth images 406G. Images 406I may include images 202, images 212, images 214 from historical image data or synthetic dataset 302.

At operation 708, machine learning system is trained. For example, machine learning system 124T may be trained using training dataset 123 or a portion of training dataset 123 over thousands or millions iterations. During training, images 406I, 406G may be passed through the layers of AI model 402 of machine learning system 124T until AI model 402 learns to generate predictions 408 that classify images 406I, 406G as images with and without die mispicks. As discussed above, during training, the weights of the neurons in AI model 402 may be modified using backtracking algorithm to minimize error over training dataset 123 as identified by a cost function.

FIG. 8 is a flowchart of a method 800 for generating a synthetic dataset, according to some embodiments. Notably, method 800 is exemplary and other methods may also be used. Method 800 may be performed using hardware and/or software components described in FIGS. 1-5. Note that one or more of the operations may be deleted, combined, or performed in a different order as appropriate.

At operation 802, an indication of an image with a shifted die is identified. For example, synthetic data generator 126 may receive text log files 116 received from server 114. The synthetic data generator 126 may include a natural language processor that may scan text log files 116 and identify an indicia, e.g., an alert that indicates that image 214 with a shifted die has been generated by die processing system 106. Notably, operation 802 may repeat multiple times to identify existence of multiple images 214 for dies having the same or different integrated circuits.

At operation 804, an image with a shifted die is identified. For example, synthetic data generator 126 may receive image log files 118 that correspond to text log files 116. Using the timestamps in text log files 116 that correspond to the indicia identified in operation 802 that image 214 exists, synthetic data generator 126 may identify image 214 in image log files 118. Notably, operation 804 may repeat multiple times to identify multiple images 214 for dies having the same or different integrated circuits.

At operation 806, a shift distance of a die is determined. For example, synthetic data generator 126 may access a ground truth image and identify a center of alignment die 206 in the ground truth image and a center of alignment die in the image identified in operation 804. In some instances, ground truth image and/or center of alignment die 206 in the ground truth image may be included in image log files 118 or stored in a memory storage accessible to synthetic data generator 126. Notably, for different integrated circuits, the size of the dies, location of the center of alignment die 206 may vary. Similarly, synthetic data generator 126 may use edge detection algorithm to determine edges of alignment die 206 in image 214, and from the edges, the center of alignment die 206. Using the center of alignment die 206 in the ground truth image and the center of alignment die 206 in the image 214, synthetic data generator 126 may determine the shift distance of alignment die 206. Notably, operation 806 may repeat for multiple images 214 identified in operation 804.

At operation 808, synthetic images are generated. For example, using the shift distance determined in operation 806, synthetic data generator 126 may crop and/or augment image 214 or ground truth image from different sides to generate synthetic dataset 302 with various images 214 having various shift distances. Notably, synthetic dataset 302 may be generated for dies with different integrated circuits, dies having different sizes, and the like.

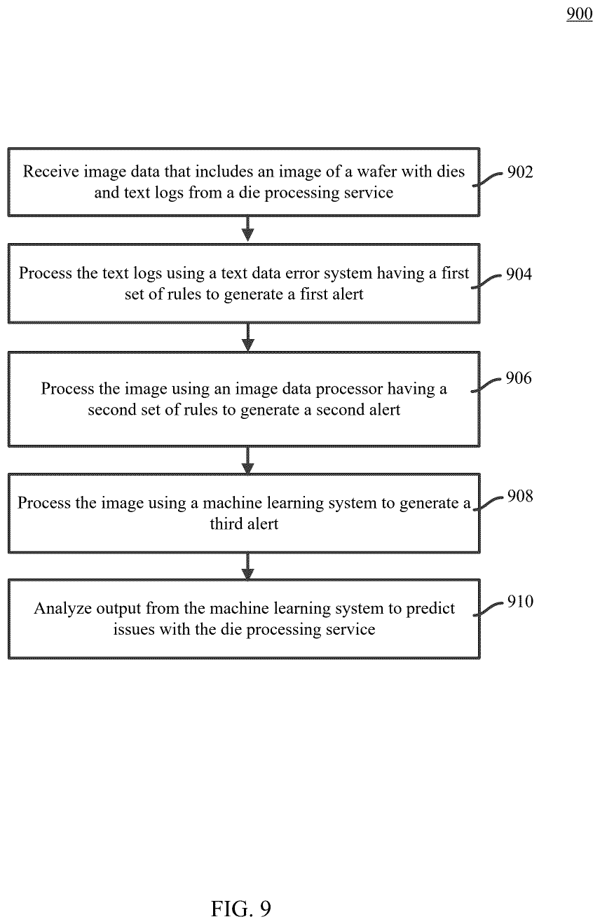

FIG. 9 is a flowchart of a method 900 for detecting a mispick die, according to some embodiments. Notably, method 900 is exemplary and other methods may also be used. Method 900 may be performed using hardware and/or software components described in FIGS. 1-5. Note that one or more of the operations may be deleted, combined, or performed in a different order as appropriate. In method 900, machine learning system 124I has been trained on training dataset 123 to identify wafers with die mispicks and is included in a computing environment 100 to detect die mispicks in real-time.

At operation 902, an image of a wafer and/or text log file is received. For example, error detection system 128 may receive image data 504 in image log file 118 and/or text data 502 in text log file 116 over network 102. Image log file 118 and text log file 116 may be received at predefined increments, when data is written into the logs, upon request from error detection system 128, from data integration server 120, and the like.

At operation 904, text data in text log files are processed. For example, text data error system 130 may process text data 502 in the text log file 116 using a set of rules, a natural language processor, and the like to identify an alert from text data. If an alert is identified, text data error system 130 may generate and transmit alert 506 to API 136. In some instances, if alert 506 is generated, method 900 ends, otherwise method 900 proceeds to operation 906. In other instances, method 900 proceeds to operation 906 regardless of whether alert 506 is generated.

At operation 906, image data in image log files are processed. For example, image data error system 132 may process image data 504 in the image log file 118 using one or more rules. An example rule may be to check the position of alignment die 206 in image 202 in image data 504 and determine if a shift distance is greater than a predefined distance. If the shift distance is greater than the predetermined distance in the rule, image data error system 132 may generate alert 508. In some instances, image data error system 132 may use an edge detection algorithm to identify edges in dies 204 displayed in image 202. Image data error system 132 may identify alignment die 206 from dies 204 and compare the center of alignment die 206 in image 202 to a center of alignment die 206 from the ground truth image for a corresponding integrated circuit to determine the shift distance. If an alert 508 is generated, image data error system 132 may transmit alert 508 to API 136. In some instances, if alert 508 is generated, method 900 ends, otherwise method 900 proceeds to operation 908. In other instances, method 900 proceeds to operation 908 regardless of whether alert 506 is generated.

At operation 908, image data in image log files is processed. For example, machine learning system 124I may receive image data 504 and propagate image 202 in image data 504 through AI model 510. AI model 510 may be AI model 402 trained to identify die mispicks by propagating images 202 in the image data 504 through layers of AI model 510 to determine score 514. If score 514 classifies image 202 as including a die mispick, machine learning system 124I may generate alert 512.

Notably, operations 904, 906, and 908, may be performed sequentially or in parallel. In this way, if one of operations 904-908 fails to generate a corresponding alert 506, 508, or 512, the alert detecting a die mispick may be generated by other operations 904-908, thereby providing a multi layered approach to detecting die mispicks using various technologies.

At operation 910, an output of a machine learning system may be analyzed. For example, analytics module 134 may analyze scores 514 generated by AI model 510 to track the state and trends in die processing service 106. For example, analytics module 134 may determine that the state of die processing service and predict potential issues with wafer grinder 108, wafer saw 110, and/or tape and reel machine(s) 112 by analyzing trends in scores 514. In another example, analytics module 134 may also include the frequency at which alerts 506 and 508 were generated in the analysis.

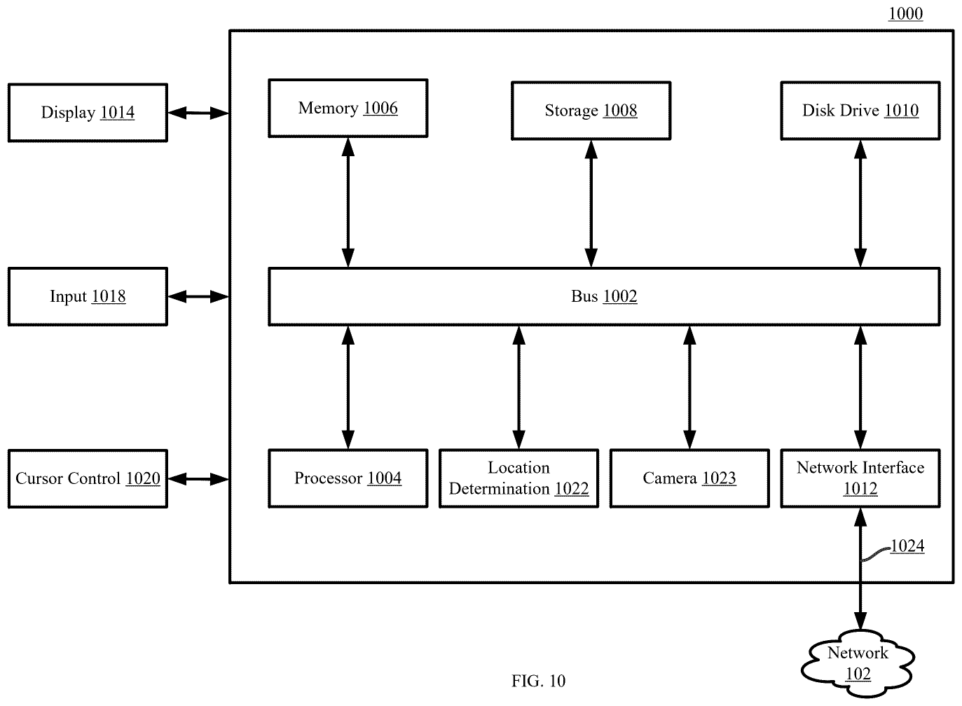

Referring now to FIG. 10 an embodiment of a computer system 1000 suitable for implementing, the systems and methods described in FIGS. 1-9 is illustrated.

In accordance with various embodiments of the disclosure, computer system 1000, such as a computer and/or a server, includes a bus 1002 or other communication mechanism for communicating information, which interconnects subsystems and components, such as a processing component 1004 (e.g., processor, micro-controller, digital signal processor (DSP), graphics processing unit (GPU), etc.), a system memory component 1006 (e.g., RAM), a static storage component 1008 (e.g., ROM), a disk drive component 1010 (e.g., magnetic or optical), a network interface component 1012 (e.g., modem or Ethernet card), a display component 1014 (e.g., CRT or LCD), an input component 1018 (e.g., keyboard, keypad, or virtual keyboard), a cursor control component 1020 (e.g., mouse, pointer, or trackball), a location determination component 1022 (e.g., a Global Positioning System (GPS) device as illustrated, a cell tower triangulation device, and/or a variety of other location determination devices known in the art), and/or a camera component 1023. In one implementation, the disk drive component 1010 may comprise a database having one or more disk drive components.

In accordance with embodiments of the disclosure, the computer system 1000 performs specific operations by the processor 1004 executing one or more sequences of instructions contained in the memory component 1006, such as described herein with respect to the mobile communications devices, mobile devices, and/or servers. Such instructions may be read into the system memory component 1006 from another computer readable medium, such as the static storage component 1008 or the disk drive component 1010. In other embodiments, hard-wired circuitry may be used in place of or in combination with software instructions to implement the disclosure.

Logic may be encoded in a computer readable medium, which may refer to any medium that participates in providing instructions to the processor 1004 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1010, volatile media includes dynamic memory, such as the system memory component 1006, and transmission media includes coaxial cables, copper wire, and fiber optics, including wires that comprise the bus 1002. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 1000. In various other embodiments of the disclosure, a plurality of the computer systems 1000 coupled by a communication link 1024 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 1000 may transmit and receive messages, data, information and instructions, including one or more programs (i.e., application code) through the communication link 1024 and the network interface component 1012. The network interface component 1012 may include an antenna, either separate or integrated, to enable transmission and reception via the communication link 1024. Received program code may be executed by processor 1004 as received and/or stored in disk drive component 1010 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A system comprising:
a non-transitory memory storing instructions; and
one or more hardware processors coupled to the non-transitory memory and configured to read the instructions from the non-transitory memory to cause the system to perform operations comprising:
providing a training dataset comprising historical image data generated by a tape and reel machine, wherein the historical image data includes images of wafers comprising dies having integrated circuits;
training, using the training dataset, a convolutional neural network comprising feature layers and fully connected layers to identify die mispicks in the images of the wafers, wherein the feature layers and the fully connected layers comprise neurons associated with corresponding weights and wherein the training comprises:
passing each image in the images of the wafers through the feature layers and the fully connected layers to generate a corresponding prediction indicating whether a die in the each image is a mispick die or not a mispick die;
determining a prediction error for the each image, wherein the prediction error indicates the prediction is a true prediction or a false prediction; and
modifying the weights of the neurons in the convolutional neural network until prediction errors are minimized.

2. The system of claim 1, wherein the images of the wafers in the historical image data are taken by a camera at the tape and reel machine.

3. The system of claim 1, wherein an image in the images of the wafers is a ground truth image that includes an alignment die placed in a center of image.

4. The system of claim 1, wherein an image in the images of the wafers includes an alignment die shifted by a shifted distance from a center of the wafer as compared to an alignment die in a ground truth image.

5. The system of claim 1, wherein an image in the images of the wafers includes a missing alignment die.

6. The system of claim 1, wherein the training dataset further comprises a synthetic dataset having images created synthetically from the historical image data.

7. The system of claim 6, further comprising:
identifying, in a text log file, an indication of an image having a shifted alignment die;
identifying, using the indication, the image in an image log file;
determining a shift distance using the shifted alignment die and an alignment die in a ground truth image; and
generating, using the shifted distance, a plurality of synthetic images using the image in the log file or the ground truth image.

8. The system of claim 7, wherein generating the plurality of synthetic images further comprises:
cropping the image in the log file or the ground truth image based on the shifted distance.

9. The system of claim 1, further comprising:
incorporating the trained convolutional neural network into a machine learning system communicatively connected to a die processing system;
receiving, at the machine learning system, an image of a wafer having a plurality of dies from the die processing system; and
determining, using the convolutional neural network, the image to include a die mispick.

10. A method comprising:
receiving, at an error detection system communicatively coupled to a die processing service, text data in a text log file and an image data in an image log file, wherein the image data comprises a plurality of images of wafers;
processing, using at least one first rule, the text data, wherein the processing generates a first alert indicating a die mispick in the image data when the at least one first rule is satisfied;
processing, using at least one second rule, the image data, wherein the processing generates a second alert indicating a die mispick when the at least one second rule is satisfied; and
processing, using a machine learning system having a neural network trained on historical image data and synthetic image data, the image data to generate a prediction, wherein the processing generates a third alert when the prediction indicates the die mispick.

11. The method of claim 10, wherein the plurality of images of wafers are taken at a tape and reel machine in the die processing service.

12. The method of claim 10, wherein the at least one first rule is satisfied when the text data indicates an error at a tape and reel machine.

13. The method of claim 10, wherein the at least one second rule is satisfied when the image data indicates a shift distance in an alignment die image by more than a predefined distance from an alignment die in a ground truth image.

14. The method of claim 10, wherein the prediction comprises a probability that an image in the image data includes the die mispick.

15. The method of claim 10, wherein the first alert, the second alert, or the third alert is transmitted to a computing device, wherein an application interface executing on the computing device is activated upon receipt of the first alert, the second alert, or the third alert and displays the first alert, the second alert, or the third alert.

16. The method of claim 10, wherein the first alert, the second alert, and the third alert are generated in parallel.

17. A non-transitory machine-readable medium having stored thereon machine-readable instructions executable to cause a machine to perform operations comprising:
receiving, at a machine learning system, weights from a trained neural network model;
incorporating the weights into a neural network model in the machine learning system;
receiving, at the machine learning system, image data, wherein the image data comprises a plurality of images of wafers generated at a die processing service; and
processing, using the machine learning system, the image data to generate a prediction, wherein the prediction indicates whether the image data includes an image of a wafer with a die mispick.

18. The non-transitory machine-readable medium of claim 17, further comprising:
collecting predictions from the machine learning system over a predefined time period; and
generating a graph indicating state of the die processing system over the predefined time period based on the predictions.

19. The non-transitory machine-readable medium of claim 17, further comprising:
generating, based on the prediction, an alert indicating presence of the die mispick, wherein the alert activates a display of an application interface on a computing device.

20. The non-transitory machine-readable medium of claim 17, wherein the neural network model is a convolutional neural network trained on historical image data from a plurality of tape and reel machines.
